(19) United States
(12) Patent Application Publication
(10) Pub. No.: US 2020/0036618 A1
(43) Pub. Date: Jan. 30, 2020

(54) POLLING IN WIRELESS SYSTEMS

(71) Applicant: QUALCOMM Incorporated, San Diego, CA (US)

(72) Inventors: Alfred Asterjadhi, San Diego, CA (US); Abhishek Pramod Patil, San Diego, CA (US); George Cherian, San Diego, CA (US)

(21) Appl. No.: 16/520,115

(22) Filed: Jul. 23, 2019

Related U.S. Application Data
(60) Provisional application No. 62/703,001, filed on Jul. 25, 2018.

(51) Int. Cl. H04L 12/26; H04W 24/02

(52) U.S. Cl. CPC H04L 43/10; H04W 84/12; H04W 24/02

(57) ABSTRACT

Access points (APs) in an AP cluster may simulate a multi-basic service set (multi-BSS) perceived by stations (STAs) in the AP cluster as a multi-BSS set. The APs may transmit a request for feedback or uplink data from the STAs through cumulative or single AP polling. APs of the AP cluster may cumulatively poll the STAs by having a first AP poll each STA. An indication of which STAs did not respond to the first AP may be sent from the first AP to a second AP in the cluster, which may poll the STAs until feedback has been received from all STAs. In another implementation, a single AP may poll all the STAs and if at least one STA does not respond, the next AP may poll all of the STAs. This process may continue until a single AP receives a response from each STA.

### CROSS REFERENCE

The present Application for Patent claims the benefit of U.S. Provisional Patent Application No. 62/703,001 by ASTERJADHI et al., entitled “POLLING IN WIRELESS SYSTEMS,” filed Jul. 25, 2018, assigned to the assignee hereof, and expressly incorporated herein.

### TECHNICAL FIELD

This disclosure relates generally to wireless communication, and more specifically, to polling in wireless systems.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Some wireless communications system deployments may operate in conditions with fast-moving and rapidly changing sources of interference and blockage. In these situations, retransmissions may be used to increase reliability. In some such deployments, transmission reliability may be increased through the use of retransmissions. Some such wireless communications systems may desire not only high reliability, but low latency. Some retransmission schemes, however, may increase the latency, potentially beyond the requirements of the latency criteria for the system to function.

### SUMMARY

The systems, methods and devices of this disclosure each have several innovative aspects, no single one of which is solely responsible for the desirable attributes disclosed herein

The described techniques relate to methods, systems, devices, or apparatuses that support polling in wireless systems. Generally, the described techniques provide for access points (APs) in an AP cluster to simulate a multi-basic service set (multi-BSS) set. The AP cluster may be perceived by one or more stations (STAs) associated with the AP cluster (for example, a STA associated with at least one AP of the AP cluster) as a multi-BSS set. As the APs appear to the STAs to be members of the same multi-BSS set, the STAs may respond to, for example, a transmitted management frame beacon or other control signaling whether the management frame beacon was transmitted by a virtual AP with which the STA is associated, or from the AP associated with a master BSS identifier (BSSID) (for example, a transmitted BSSID (TxBSSID) associated with a master AP of the AP cluster). In some implementations, the APs may transmit a request such as a Null Data Packet (NDP) Feedback Report Poll (NFRP), to solicit feedback from the STAs or a request to solicit uplink data from the STAs.

APs of the AP cluster may cumulatively poll the STAs in which any of the APs may transmit a NFRP to each of the STAs to solicit feedback from the STAs indicating whether each of the STAs has uplink buffered data to be transmitted. For the STAs that the AP did not receive a response from, the transmitting AP may signal to at least one second AP of the cluster to transmit an additional NFRP to determine whether the non-responding STA is reachable by the at least one second AP. This process may continue through each of the APs (for example, until a response has been received from each of the STAs). Similarly, a trigger frame may be sequentially transmitted from each of the APs until the uplink data has been received from each of the STAs that indicated having buffered uplink data to transmit.

Another implementation may include polling from a single APs to all of the associated STAs in which one AP may transmit an NFRP to solicit feedback from each of the STAs of the cluster. If at least one STA does not respond to the NFRP, the next AP may similarly transmit an NFRP to reach all of the STAs and this may continue until a single AP receives a response from each of the STAs.

One innovative aspect of the subject matter described in this disclosure can be implemented in a method for wireless communication at a first AP of a set of APs of an AP cluster. The method may include transmitting a request message to a set of STAs associated with the set of APs of the AP cluster, the request message indicating a master BSSID of the AP cluster, monitoring for responses from the set of STAs in response to the transmitted request message, and providing, to at least one second AP of the set of APs, an indication of whether responses were received from STAs of the set of STAs based on the monitoring.

Another innovative aspect of the subject matter described in this disclosure can be implemented in an apparatus for wireless communications at a first AP of a set of APs of an AP cluster. The apparatus may include a processor, memory coupled with the processor, and instructions stored in the memory. The instructions may be executable by the processor to cause the apparatus to transmit a request message to a set of STAs associated with the set of APs of the AP cluster, the request message indicating a master BSSID of the AP cluster, monitor for responses from the set of STAs in response to the transmitted request message, and provide, to at least one second AP of the set of APs, an indication of whether responses were received from STAs of the set of STAs based on the monitoring.

Another innovative aspect of the subject matter described in this disclosure can be implemented in an apparatus for wireless communications at a first AP of a set of APs of an AP cluster. The apparatus may include means for transmitting a request message to a set of STAs associated with the set of APs of the AP cluster, the request message indicating a master BSSID of the AP cluster, monitoring for responses from the set of STAs in response to the transmitted request message, and providing, to at least one second AP of the set of APs, an indication of whether responses were received from STAs of the set of STAs based on the monitoring.

Another innovative aspect of the subject matter described in this disclosure can be implemented in a non-transitory computer-readable medium storing code for wireless communications at a first AP of a set of APs of an AP cluster. The code may include instructions executable by a processor to transmit a request message to a set of STAs associated with the set of APs of the AP cluster, the request message indicating a master BSSID of the AP cluster, monitor for responses from the set of STAs in response to the transmitted request message, and provide, to at least one second AP of the set of APs, an indication of whether responses were received from STAs of the set of STAs based on the monitoring.

In some implementations of the method, apparatuses, and non-transitory computer-readable medium described herein, the request message includes a transmitter address corresponding to a master AP of the AP cluster.

Some implementations of the method, apparatuses, and non-transitory computer-readable medium described herein may further include operations, features, means, or instructions for receiving a first response message from a first STA of the set of STAs in response to the transmitted request message based on the monitoring, where the indication provided to the at least one second AP indicates that the first response message was received from the first STA.

Some implementations of the method, apparatuses, and non-transitory computer-readable medium described herein may further include operations, features, means, or instructions for determining that the first STA of the set of STAs has uplink data buffered based at least in part on the first response message, transmitting a trigger frame to the first STA, where the trigger frame comprises the transmitter address, and receiving a trigger response from the first STA, wherein the trigger response comprises a receiver address set to a media access control (MAC) address of a virtual AP associated with the first STA.

Some implementations of the method, apparatuses, and non-transitory computer-readable medium described herein may further include operations, features, means, or instructions for transmitting a feedback message to the first STA, where a transmitter address of the feedback message is set to the receiver address.

In some implementations of the method, apparatuses, and non-transitory computer-readable medium described herein, the first AP is the master AP of the set of APs.

Some implementations of the method, apparatuses, and non-transitory computer-readable medium described herein may further include operations, features, means, or instructions for transmitting a management frame beacon that indicates that the master BSSID is associated with the master AP.

Some implementations of the method, apparatuses, and non-transitory computer-readable medium described herein may further include operations, features, means, or instructions for determining that at least one STA has not responded to the transmitted request message based on the monitoring, where the indication provided to the at least one second AP indicates that the at least one STA has not responded to the transmitted request message.

Some implementations of the method, apparatuses, and non-transitory computer-readable medium described herein may further include operations, features, means, or instructions for receiving, from the at least one second AP, a backhaul message that indicates a response from the at least one STA.

In some implementations of the method, apparatuses, and non-transitory computer-readable medium described herein, each AP of the set of APs corresponds to a same multiple BSSID (multi-BSSID) set.

Some implementations of the method, apparatuses, and non-transitory computer-readable medium described herein may further include operations, features, means, or instructions for receiving response messages from a subset of STAs of the set of STAs based on the monitoring, and transmitting respective trigger frames to each of the subset of STAs having uplink data buffered based on the received response messages.

Some implementations of the method, apparatuses, and non-transitory computer-readable medium described herein may further include operations, features, means, or instructions for transmitting a management frame beacon that indicates the master BSSID is associated with a master AP, wherein the first AP is not the master AP.

In some implementations of the method, apparatuses, and non-transitory computer-readable medium described herein, the request message comprises a trigger frame.

In some implementations of the method, apparatuses, and non-transitory computer-readable medium described herein, the trigger frame comprises a NFRP.

Some implementations of the method, apparatuses, and non-transitory computer-readable medium described herein may further include operations, features, means, or instructions for receiving, from a third AP of the set of APs, an indication of whether responses to a second request message were received from one or more STAs of the set of STAs, where the second request message indicates the master BSSID of the AP cluster, and where the transmitting of the request message is based on the indication received from the third AP.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 shows a pictorial diagram of an example wireless communications system.

FIGS. 2A and 2B show example frames usable for communications between an AP and each of a number of stations identified by the AP that support polling in wireless systems in accordance with aspects of the present disclosure.

FIG. 3 shows a block diagram of an example AP 300 for use in wireless communications that supports polling in wireless systems in accordance with aspects of the present disclosure.

FIG. 4 shows a block diagram of an example STA 400 for use in wireless communications that supports polling in wireless systems in accordance with aspects of the present disclosure.

FIG. 5 illustrates an example of a wireless communications system that supports polling in wireless systems in accordance with aspects of the present disclosure.

FIG. 6 illustrates an example of a process flow that supports polling in wireless systems in accordance with aspects of the present disclosure.

FIGS. 7 and 8 show block diagrams of devices that support polling in wireless systems in accordance with aspects of the present disclosure.

FIG. 9 shows a block diagram of a communications manager that supports polling in wireless systems in accordance with aspects of the present disclosure.

FIG. 10 shows a diagram of a system including a device that supports polling in wireless systems in accordance with aspects of the present disclosure.

FIGS. 11 through 14 show flowcharts illustrating methods that support polling in wireless systems in accordance with aspects of the present disclosure.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to a wireless local area network (WLAN) (for example, Wi-Fi), but it should be appreciated that the described techniques may be similarly applied to a variety of radio access technologies (RATs) in a variety of deployments. Some wireless communications system deployments may operate in conditions with fast-moving and rapidly changing sources of interference and blockage. For example, in an Industrial Internet of things (IIoT) network, robotic arms, automatic guided vehicles (AGVs), cranes, conveyer belts, etc., may move in and out of established communication links to the various devices in the wireless communications system. This may lead to, for example, link blockage such that the devices may not be able to fully rely on that single communication link, and/or reflection (for example, off of metal objects) may cause rapidly varying interference with communications.

In some such deployments, transmission reliability may be increased through the use of retransmissions. Some wireless communications systems, for example, IIoT applications, may desire not only high reliability, but low latency. Some retransmission schemes, however, may increase the latency, potentially beyond the requirements of the latency criteria for the system to function (a system may set criteria of, for example, a failure rate of 10⁻² to 10⁻⁴, with a latency in the tens of ms). Further, short-distance and/or faster retransmissions may also fail in some applications. For example, a robot arm may move to a new location and thereby block a communication link, and potentially remain in that location for some time, such that a retransmission on the same communication link would not be effective. The described techniques provide solutions to these link blockage and interference scenarios through the use of particular media access control (MAC) layer signaling techniques with existing physical (PHY) layer signaling. In some examples, the described techniques may be implemented in extreme high throughput (EHT) environments, such as those implementing IEEE 802.11be.

Techniques are provided for a WLAN that supports virtual access point (AP) capabilities. The WLAN may include one or more APs and one or more stations (STAs) that may associate with the APs to form a basic service set (BSS). Virtual APs may simulate the operations of multiple APs and each may be associated with its own BSS identifier (BSSID). An AP may support communications over a primary channel using a first virtual AP and may support communications over one or more secondary channels using respective other virtual APs. In some examples, the BSSID associated with the first virtual AP may be referred to as the transmitted BSSID (for example, a TxBSSID), while the BSSIDs associated with the other virtual APs may be referred to as non-transmitted BSSIDs (for example, a non-TxBSSID). In some examples, however, with a number n of virtual APs, the same number n of beacon frames may be used, which may consume a relatively larger amount of airtime than a system using a one-to-one correspondence between physical APs to BSSs. Techniques describes herein provide for multiple BSS (multi-BSS) signaling schemes for virtual APs that may provide for various benefits, including those related to airtime consumption.

According to the techniques described herein, each of the APs may belong to an IIoT cluster. The APs in the IIoT cluster may simulate a single multi-BSS set. For example, the APs in the IIoT cluster may pretend to be, as perceived by the STAs, a group of APs connected to the same local network. That is, the APs may appear to the STAs to each be part of the same multi-BSS set. This may, in some cases, allow STAs to roam from AP to AP in the IIoT cluster without re-configuring a connection between a given STA and an AP. In some examples, one of the APs may be designated as a master AP of the multi-BSS set. The master AP transmitting the management frame beacon may indicate a TxBSSID with which the master AP is associated (for example, the TxBSSID may be a BSSID of one of the virtual APs supported by the master AP or a MAC address of the master AP).

The STAs may associate with an AP in their vicinity (their “neighborhood”). The STAs may then communicate with the respectively associated APs, for example, via respective communication links. As the APs appear to the STAs to be members of the same multi-BSS set, the STAs may respond to, for example, a transmitted management frame beacon or other control signaling whether the management frame beacon was transmitted by a virtual AP with which the STA is associated, or from the AP associated with the TxBSSID. In some implementations, the APs may transmit a poll (in other words, a feedback request such as a Null Data Packet (NDP) Feedback Report Poll (NFRP)), to solicit feedback from the STAs.

In some implementations, the APs or virtual APs of a multi-BSS set (for example, multiple APs in an IIoT cluster or multiple virtual APs supported by an AP of the multi-BSS set) may cumulatively poll the STAs in the cluster for reports of buffered uplink data. In some such implementations using cumulative polling, any of the APs may transmit a NFRP to the STAs to solicit feedback from the STAs as to whether each of the STAs has uplink buffered data to be transmitted. A STA that receives the NFRP may reply by indicating whether or not the STA has buffered uplink data to transmit. A first transmitting AP may receive a number of responses from STAs in the cluster during cumulative polling. In some cases, however, the first transmitting AP may determine that it did not receive a response from a number of other STAs in the cluster. As a result, the first transmitting AP may signal to at least one second transmitting AP of the cluster to transmit a further NFRP (e.g., to the STAs that were unresponsive to the first transmitting AP) to determine whether the STAs that did not respond to the first transmitting AP are reachable by the at least one second transmitting AP. This process may continue in a similar manner where STAs that were unresponsive to a previous AP are signaled by another AP in the cluster until the APs determine that a response has been received (e.g., cumulatively received at the APs) from each of the STAs. For example, if a STA or group of STAs were unresponsive to the first transmitting AP, and further unresponsive to the second transmitting AP, a third AP may poll the unresponsive STA or group of STAs, and so on, until all STAs have responded to at least one of the APs.

Once the APs have collectively received a response from each of the STAs, the APs may transmit trigger frames to the STAs to trigger the STAs to transmit their respective buffered uplink data. The trigger frames may be transmitted cumulatively in a similar manner as the NFRPs were transmitted, for example. Then, for each of the responses an AP receives, the AP may transmit an acknowledgement (ACK) or block ACK to the respective responding STA. After the AP has acknowledged each of the STAs from which the AP has received uplink data, the AP may signal to at least one second AP to continue transmitting trigger frames to the remaining STAs that have buffered uplink data to transmit that the first AP may not have been able to receive. In this way, trigger frames may be sequentially or concurrently transmitted from the STAs each of the APs until the uplink data has been received from each of the STAs that indicated having buffered uplink data to transmit.

Some other implementations may include polling from APs to all of the associated STAs. According to some such implementations, a single AP may transmit an NFRP to solicit feedback from each of the STAs of the cluster. In some such implementations, if at least one STA does not respond to the NFRP, a next AP may transmit an NFRP to each of the STAs of the cluster in an attempt to reach all of the STAs of the cluster. NFRP transmissions may be repeated from other APs in the cluster until at least one AP in the cluster has been able to receive a response from all of the STAs in the cluster.

Some other implementations may include polling from multiple APs to the associated STAs. In some implementations, the polling may be from all of the APs of the multi-BSS set or from each virtual AP supported by the APs of the multi-BSS set (in other words, each of the virtual APs may separately transmit NFRPs). The multiple APs may each transmit the NFRPs to solicit feedback from the STAs, as similarly described. In some examples, the multiple APs may not wait until receiving signaling from another AP to initiate NFRP polling.

Particular implementations of the subject matter described in this disclosure can be implemented to realize one or more of the following potential advantages. In some implementations, the described techniques can be used to reduce the latency of transmissions at an AP or multiple APs and increase the signal strength of such transmissions. As a result, the reliability by which the transmissions are sent or received may increase, along with the efficiency of various processes in the wireless communication network. In addition, the described techniques may reduce the quantity of retransmissions occurring in the system, which may reduce power consumption at devices (such as STAs) in the system.

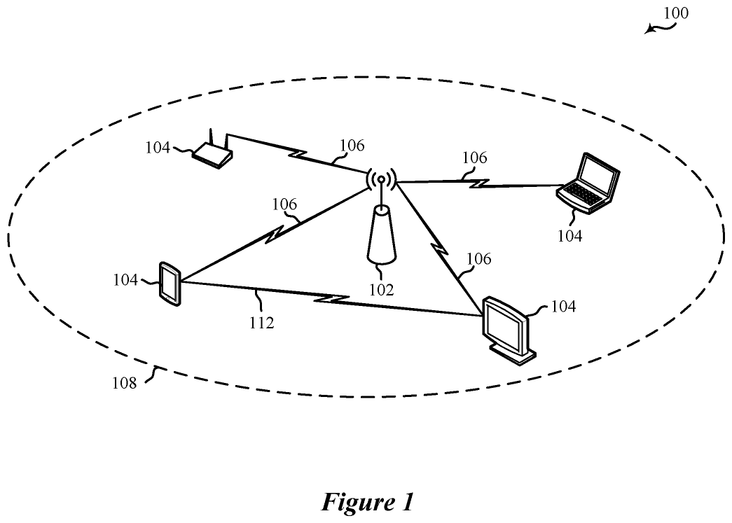

FIG. 1 shows a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 100 may include numerous wireless communication devices such as an AP 102 and multiple STAs 104. While only one AP 102 is shown, the WLAN 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a BSS, which is managed by the respective AP 102. FIG. 1 additionally shows an example coverage area 108 of the AP 102, which may represent a basic service area (BSA) of the WLAN 100. The BSS may be identified to users by a service set identifier (SSID), as well as to other devices by a BSSID, which may be a media access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 112. Additionally, two STAs 104 may communicate via a direct wireless link 112 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 112 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to the IEEE 802.11 family of standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and media access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PLCP service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

In some particular implementations, the WLAN 100 may support virtual AP capabilities. A virtual AP 105 may simulate the operations of multiple APs 105 (for example, one physical AP 105 may support up to 32 different virtual APs 105). Accordingly, each BSS (for example, or subset of the multiple BSSs) may be associated with one or more virtual APs. A virtual AP may refer to functionality provided by an AP while a BSS may refer to a group of STAs associated with the AP, but in aspects of the following the two may be used interchangeably. An AP may support communications over a primary channel using a first virtual AP (for example, having a first BSSID) and may support communications over one or more secondary channels using respective other virtual APs (for example, each having a second BSSID). In some examples, the BSSID associated with the first virtual AP may be referred to as the transmitted BSSID (for example, a TxBSSID), while the BSSIDs associated with the other virtual APs may be referred to as non-transmitted BSSIDs (for example, a non-TxBSSID). In some examples, each secondary channel supported by the AP (for example, a secondary channel may refer to a 20 MHz channel, a 40 MHz channel, and the like) may be associated with a respective virtual AP having a unique BSSID. In some examples, however, with a number n of virtual APs, the same number n beacon frames may be used, which may consume a relatively larger amount of airtime than a system using a one-to-one correspondence between physical APs to BSSs. Techniques describes herein provide for multi-BSS signaling schemes for virtual APs 105 that may provide for, various benefits, including those related to airtime consumption.

Particular implementations of the subject matter described in this disclosure can be implemented to realize one or more of the following potential advantages. In some implementations, the described techniques can be used to reduce the latency of transmissions at an AP or multiple APs and increase the signal strength of such transmissions. As a result, the reliability of which the transmissions are sent or received may increase, along with the efficiency of various processes in the wireless communication network. In addition, the described techniques may reduce the amount of retransmissions occurring in the system, which may reduce power consumption at devices in the system

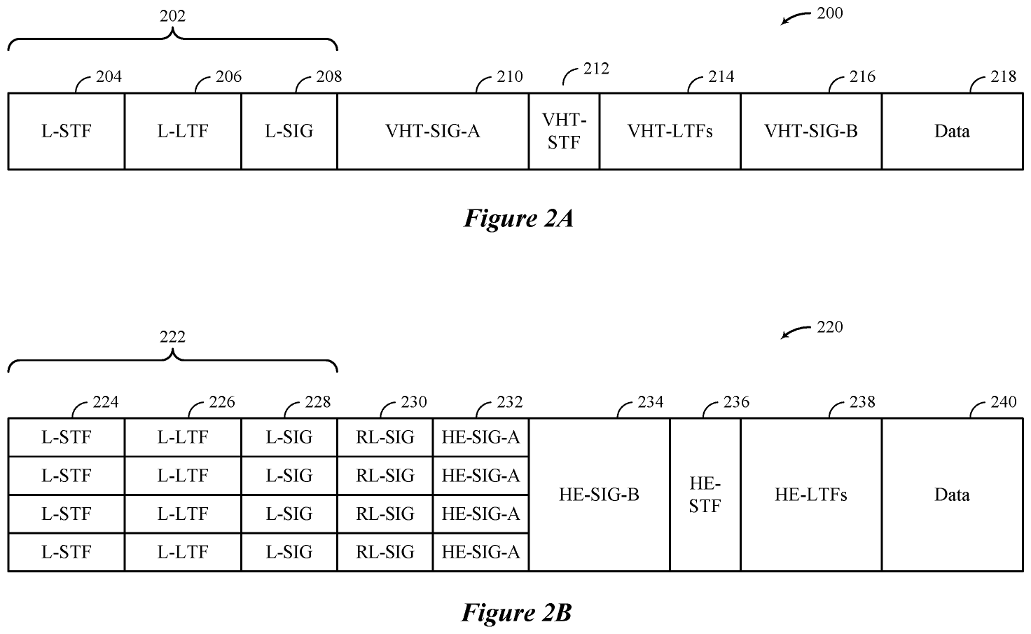

FIG. 2A shows an example frame 200 usable for communications between an AP and each of a number of stations identified by the AP that support polling in wireless systems in accordance with aspects of the present disclosure. For example, the frame 200 can be formatted as a very high throughput (VHT) frame in accordance with the IEEE 802.11ac amendment to the IEEE 802.11 set of standards. The frame 200 includes a legacy preamble portion 202 that includes a legacy short training field (L-STF) 204, a legacy long training field (L-LTF) 206, and a legacy signaling field (L-SIG) 208. The frame 200 further includes a non-legacy preamble portion that includes a first very high throughput (VHT) signaling field (VHT-SIG-A) 210, a VHT short training field (VHT-STF) 212, a number of VHT long training fields (VHT-LTFs) 214 and a second VHT signaling field (VHT-SIG-B) 216. The frame 200 also can include a payload or data portion 218 after the preamble. The data portion 218 can include MAC protocol data units (MPDUs), for example, in the form of an aggregated MPDU (AMPDU).

The frame 200 may be transmitted over a radio frequency spectrum band, which may include a number of sub-bands. For example, the radio frequency spectrum band may have a bandwidth of 80 MHz, and each of the sub-bands may have a bandwidth of 20 MHz. When the radio frequency spectrum band includes a number of sub-bands, the L-STF, L-LTF, and L-SIG fields 204, 206 and 208, respectively, may be duplicated and transmitted in each of the number of sub-bands. The information in the VHT-SIG-A field 210 is also duplicated and transmitted in each sub-band.

The VHT-SIG-A field 210 may indicate to a station that the frame 200 is an IEEE 802.11ac frame. The VHT-SIG-A field 210 also may include VHT WLAN signaling information usable by stations other than the number of stations that are identified to receive downlink communications in the frame 200. The VHT-SIG-A field 210 also includes information usable by the identified number of stations to decode the VHT-SIG-B field 216. The VHT-SIG-B field 216 may include VHT WLAN signaling information usable by the number of stations identified to receive downlink communications in the frame 200. More specifically, the VHT-SIG-B field 216 may include information usable by the number of stations to decode data received in the data portion 218. The VHT-SIG-B field 216 may be encoded separately from the VHT-SIG-A field 210. The number of VHT-LTFs 214 depends on the number of transmitted streams.

FIG. 2B shows an example frame 220 usable for communications between an AP and each of a number of stations identified by the AP that support polling in wireless systems in accordance with aspects of the present disclosure. For example, the frame 220 can be formatted as a high efficiency (HE) frame in accordance with the IEEE 802.11ax amendment to the IEEE 802.11 set of standards. The frame 220 includes a legacy preamble portion 222 that includes a legacy short training field (L-STF) 224, a legacy long training field (L-LTF) 226, and a legacy signaling field (L-SIG) 228. The frame 220 further includes a non-legacy preamble portion that includes a repeated legacy signaling field (RL-SIG) 230, a first high efficiency signaling field (HE-SIG-A) 232, a second high efficiency signaling field (HE-SIG-B) 234, a high efficiency short training field (HE-STF) 236 and a number of high efficiency long training fields (HE-LTFs) 238. The frame 220 also can include a payload or data portion 240 after the preamble. The data portion 240 can include MPDUs, for example, in the form of an AMPDU.

The frame 220 may be transmitted over a radio frequency spectrum band, which may include a number of sub-bands. For example, the radio frequency spectrum band may have a bandwidth of 80 MHz, and each of the sub-bands may have a bandwidth of 20 MHz. When the radio frequency spectrum band includes a number of sub-bands, the L-STF, L-LTF, and L-SIG fields 224, 226 and 228, respectively, may be duplicated and transmitted in each of the number of sub-bands. The information in the RL-SIG field 230 and the HE-SIG-A field 232 is also duplicated and transmitted in each sub-band as shown in FIG. 2B.

The RL-SIG field 230 may indicate to a station that the frame 220 is an IEEE 802.11ax frame. The HE-SIG-A field 232 may include high efficiency WLAN signaling information usable by stations other than the number of stations that are identified to receive downlink communications in the frame 220. The HE-SIG-A field 232 may also include information usable by the identified number of stations to decode the HE-SIG-B field 234. The HE-SIG-B field 234 may include high efficiency WLAN signaling information usable by the number of stations identified to receive downlink communications in the frame 220. More specifically, the HE-SIG-B field 234 may include information usable by the number of stations to decode data received in the data portion 240. The HE-SIG-B field 234 may be encoded separately from the HE-SIG-A field 232.

High efficiency (HE) WLAN (HEW) preambles can be used to schedule multiple devices, such as STAs 115, for multi-user simultaneous transmissions (for example, using multi-user orthogonal frequency division multiple access (MU-OFDMA) or multi-user multiple-input, multiple-output (MU-MIMO) techniques). A HEW signaling field may be used to signal a resource allocation pattern to multiple receiving STAs 115. The HEW signaling field can include a common user field that is decodable by multiple STAs 115, as well as a resource allocation field. The resource allocation field can indicate resource unit distributions to multiple STAs 115 and indicate which resource units in a resource unit distribution correspond to MU-MIMO transmissions and which resource units correspond to OFDMA transmissions. The HEW signaling field also can include, subsequent to the common user field, dedicated station-specific signaling fields that are assigned to particular STAs 115 and used to schedule resources and to indicate the scheduling to other WLAN devices.

In some implementations, aspects of transmissions may vary based on a distance between a transmitter (for example, AP 105) and a receiver (for example, STA 115). WLAN 100 may otherwise generally benefit from AP 105 having information regarding the location of the various STAs 115 within coverage area 120. In some examples, relevant distances may be computed using round-trip time (RTT) based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs). For example, such RTT-based ranging functionality may be employed in developing “relative geofencing” applications (in other words, applications in which there is a geofence relative to an object of interest such as a mobile device, a car, a person, and so on). Various such examples are considered in accordance with aspects of the present disclosure. For example, car keys may employ RTT estimation for PKES systems. RTT-based geofences around an adult may monitor the position of a child within the geofence. Additionally, drone-to-drone and car-to-car RTT functionality may help prevent collisions.

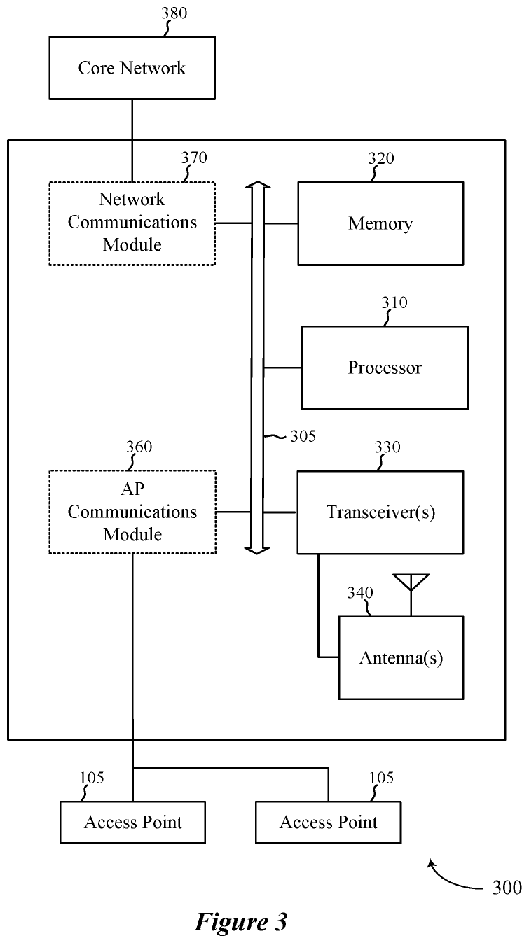

FIG. 3 shows a block diagram of an example AP 300 for use in wireless communications that supports polling in wireless systems in accordance with aspects of the present disclosure. For example, the AP 300 may be an example of aspects of the AP 105 described with reference to FIG. 1. The AP 300 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The AP 300 includes a processor 310, a memory 320, at least one transceiver 330 and at least one antenna 340. In some implementations, the AP 300 also includes one or both of an AP communications module 360 and a network communications module 370. Each of the components (or “modules”) described with reference to FIG. 3 can communicate with one another, directly or indirectly, over at least one bus 305.

The memory 320 can include random access memory (RAM) and read-only memory (ROM). The memory 320 also can store processor- or computer-executable software code 325 containing instructions that, when executed by the processor 310, cause the processor to perform various functions described herein for wireless communications, including generation and transmission of a downlink frame and reception of an uplink frame.

The processor 310 can include an intelligent hardware device such as, for example, a central processing unit (CPU), a microcontroller, an application-specific integrated circuit (ASIC), or a programmable logic device such as a field programmable gate array (FPGA), among other possibilities. The processor 310 processes information received through the transceiver 330, the AP communications module 360, and the network communications module 370. The processor 310 also can process information to be sent to the transceiver 330 for transmission through the antenna 340, information to be sent to the AP communications module 360, and information to be sent to the network communications module 370. The processor 310 can generally be configured to perform various operations related to generating and transmitting a downlink frame and receiving an uplink frame.

The transceiver 330 can include a modem to modulate packets and provide the modulated packets to the antenna 340 for transmission, as well as to demodulate packets received from the antenna 340. The transceiver 330 can be implemented as at least one RF transmitter and at least one separate RF receiver. The transceiver 330 can communicate bi-directionally, via the antenna 340, with at least one STA 115 as, for example, shown in FIG. 1. Although only one transceiver 330 and one antenna 340 are shown in FIG. 3, the AP 300 can typically include multiple transceivers 330 and antennas 340. For example, in some AP implementations, the AP 300 can include multiple transmit antennas (each with a corresponding transmit chain) and multiple receive antennas (each with a corresponding receive chain). The AP 300 may communicate with a core network 380 through the network communications module 370. The system also may communicate with other APs, such as APs 105, using the AP communications module 360.

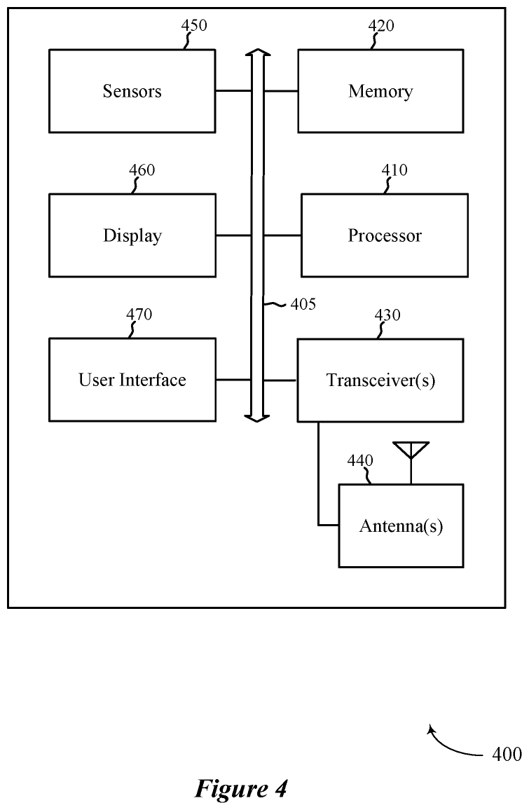

FIG. 4 shows a block diagram of an example STA 400 for use in wireless communications that supports polling in wireless systems in accordance with aspects of the present disclosure. For example, the STA 400 may be an example of aspects of the STA 115 described with reference to FIG. 1. The STA 400 can be configured to send and receive WLAN frames (also referred to herein as transmissions or communications) conforming to an IEEE 802.11 standard (such as the 802.11ac or 802.11ax amendments to the 802.11 family of standards), as well as to encode and decode such frames. The STA 400 includes a processor 410, a memory 420, at least one transceiver 430 and at least one antenna 440. In some implementations, the STA 400 additionally includes one or more of sensors 450, a display 460 and a user interface (UI) 470 (such as a touchscreen or keypad). Each of the components (or “modules”) described with reference to FIG. 4 can communicate with one another, directly or indirectly, over at least one bus 405.

The memory 420 can include RAM and ROM. The memory 420 also can store processor- or computer-executable software code 425 containing instructions that, when executed, cause the processor 410 to perform various functions described herein for wireless communications, including reception of a downlink frame and generation and transmission of an uplink frame.

The processor 410 includes an intelligent hardware device such as, for example, a CPU, a microcontroller, an ASIC or a programmable logic device such as an FPGA, among other possibilities. The processor 410 processes information received through the transceiver 430 as well as information to be sent to the transceiver 430 for transmission through the antenna 440. The processor 410 can be configured to perform various operations related to receiving a downlink frame and generating and transmitting an uplink frame.

The transceiver 430 can include a modem to modulate packets and provide the modulated packets to the antenna 440 for transmission, as well as to demodulate packets received from the antenna 440. The transceiver 430 can be implemented as at least one RF transmitter and at least one separate RF receiver. The transceiver 430 can communicate bi-directionally, via the antenna 440, with at least one AP 105 as, for example, shown in FIG. 1. Although only one transceiver 430 and one antenna 440 are shown in FIG. 4, the STA 400 can include two or more antennas. For example, in some STA implementations, the STA 400 can include multiple transmit antennas (each with a corresponding transmit chain) and multiple receive antennas (each with a corresponding receive chain).

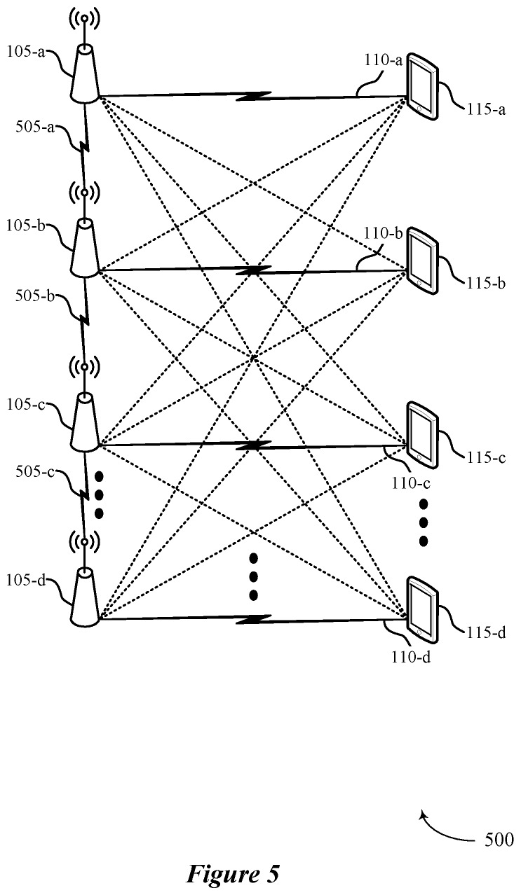

FIG. 5 illustrates an example of a wireless communications system 500 that supports polling in wireless systems in accordance with aspects of the present disclosure. The wireless communications system 500 may include a first AP 105-a, at least one second AP 105-b, a third AP 105-c, and a fourth AP 105-d. The wireless communications system 500 may also include a first STA 115-a, a second STA 115-b, a third STA 115-c, and a fourth STA 115-d. In some implementations, each of the APs 105 and the STAs 115 may be examples of the AP 105 and the STAs 115 as described with reference to FIGS. 1-4. While FIG. 5 shows four APs 105 and four STAs 115, the wireless communications system 500 may include any number of APs 105 and STAs 115.

The APs 105 and the STAs 115 may communicate over respective communication links 110. For example, the AP 105-a may communicate with the STA 115-a using a communication link 110-a, the AP 105-b may communicate with the STA 115-b using a communication link 110-b, the AP 105-c may communicate with the STA 115-c using a communication link 110-c, and the AP 105-d may communicate with the STA 115-d using a communication link 110-d. The communication links 110 may be examples of the communication links as described with reference to FIG. 1. The APs 105 may also communicate with each other via one or more backhaul links 505. As shown in FIG. 5, the AP 105-a and the AP 105-b may communicate using a backhaul link 505-a, the AP 105-b and the AP 105-c may communicate using a backhaul link 505-b, and the AP 105-c and the AP 105-d may communicate using a backhaul link 505-c. As shown in FIG. 5, the dashed lines between each of the APs 105 to each of the STAs 115 may represent other potential communication links for transmissions between the various APs 105 and STAs 115.

Each of the APs 105 shown in FIG. 5 may belong to an Industrial Internet of things (IIoT) cluster. The APs 105 in the IIoT cluster may simulate a single multi-BSS set (in other words, pretend to be, as perceived by the STAs 115). That is, the APs 105 may appear to the STAs 115 to each be part of the same multi-BSS set. In one implementation, the APs 105 of the cluster may take turns transmitting management frame beacons and other management frames. For example, the AP 105-a may first transmit a management frame beacon, followed by AP 105-b, and so on. In some implementations, one of the APs 105 may be designated as a master AP 105. The master AP 105 may, for example, be designated as the master AP 105 by a controller, which may be implemented as a separate device in communication with the APs 105, or the controller may be one of the APs 105. The master AP 105 transmitting the management frame beacon may indicate a transmitted BSSID (for example, a TxBSSID) with which the master AP 105 is associated.

The STAs 115 may associate with an AP 105 in the neighborhood. The STAs 115 may then communicate with the respectively associated APs 105, for example, via respective communication links 110. The STAs 115 may select a respective AP 105 with which to associate based on criteria such as signal strength, latency, and the like. In some implementations, the STAs may associate with the APs 105 that are not designated associated with the TxBSSID. As the APs 105 appear to the STAs 115 to be members of the same multi-BSS set, the STAs 115 may respond to, for example, a transmitted management frame beacon or other control signaling whether the management frame beacon was transmitted by a virtual AP with which the STA 115 is associated, or from the AP 105 associated with the TxBSSID. In some implementations, the APs 105 may transmit a feedback request (for example, an NFRP) to solicit feedback from the STAs 115. In the multi-BSS system show in in FIG. 5, the NFRP may be used to solicit feedback from STAs 115 that may otherwise operate in different BSSs.

A first possible implementation may include cumulative polling by the APs 105 of the cluster. In the first implementation using cumulative polling, any of the APs 105 may transmit a NFRP to each of the STAs 115 to solicit feedback from the STAs 115 as to whether each of the STAs 115 has uplink buffered data to be transmitted. In some implementations, the AP 105 that transmitted the NFRP (in other words, an initiating AP 105) may be the master AP 105. The initiating AP 105 may set a TA to the TxBSSID. A STA 115 that receives the NFRP may then respond, as the STA 115 believes that the initiating AP 105 is from its respective BSS because the NFRP appears to originate from the TxBSSID with which the STA 115 believes it is associated.

A STA 115 that receives the NFRP may reply by indicating whether or not the STA 115 has buffered uplink data to transmit. For example, the STA 115 may transmit a message including an information element (IE) including one or more bits that indicate that the STA 115 has buffered uplink data to transmit (for example, via a value of “1”) or that indicate that the STA 115 does not have buffered uplink data to transmit (for example, a value of “−1”). Based on the responses that the transmitting AP 105 receives, the AP 105 may identify the STAs 115 that have buffered uplink data to transmit, as well as the STAs 115 from which the AP 105 did not receive a response (for example, a STA 115 that may not have successfully received the NFRP due to interference or a collision). For the STAs 115 that the AP 105 determines it did not receive a response from, the transmitting AP 105 may signal to at least one second AP 105 of the cluster to transmit a further NFRP to determine whether the non-responding STA 115 is reachable by the at least one second AP 105. This second AP 105 may also set the TA for the second NFRP to the TxBSSID. As such, a STA 115 that receives this second NFRP may respond because the second NFRP appears to originate from the same TxBSSID with which the STA 115 believes it is associated. This process may continue in a similar manner through each of the APs 105 in the cluster until the APs determine that a response has been received from each of the STAs 115. The APs 105 that receive a response from one or more STAs may indicate the information from the response to the master AP 105 via a respective backhaul link 505.

Once the APs 105 have received a response from each of the STAs 115, the APs 105 may transmit trigger frames to the STAs 115 to trigger the STAs 115 to transmit their respective buffered uplink data. The trigger frames may be transmitted in a similar manner as the NFRPs were transmitted. The transmitted AP 105 may similarly set a TA for the trigger frame as the TxBSSID, as similarly described for transmitting an NFRP. For example, a first AP 105, for example AP 105-a, may transmit a first trigger frame to each of the STAs 115 (in other words, a trigger frame burst) that have buffered uplink data to transmit. A STA 115 receiving the trigger frame from the AP 105-a may, in response, transmit its respective buffered uplink data to the AP 105-a. In the transmitted responses, the transmitting STA 115 may indicate a receiving address set to the MAC of the virtual AP 105 with which the STA 115 is associated. Then, for each of the responses the AP 105-a receives, the AP 105-a may transmit an ACK or block ACK to the respective responding STAs 115 with a TA corresponding to the receiver address for the respective STA 115. In some examples, the first transmitting AP 105-a may block a relatively longer transmission opportunity (TxOP) to provide for subsequent trigger frame transmissions from one or more of the remaining APs 105.

After the AP 105-a has acknowledged each of the STAs 115 from which the AP 105-a has received uplink data, the AP 105-a may signal (for example, via the backhaul link 505-a) to second AP 105 (for example, AP 105-b) to continue transmitting trigger frames to the remaining STAs 115 that have buffered uplink data to transmit, but that the first AP 105-a may not have been able to receive. In this way, trigger frame may be sequentially transmitted from each of the APs 105 until the uplink data has been received from each of the STAs 115 that indicated having buffered uplink data to transmit.

A second possible implementation may include polling from a single APs 105 to all of the associated STAs 115. The APs 105 may transmit the NFRPs to solicit feedback from the STAs 115 as similarly described in the first implementation of cumulative polling. In the second implementation, if at least one STA 115 does not respond to the NFRP, the next AP 105 may similarly transmit a further NFRP to attempt to reach each of the STAs 115. As described herein, the NFRP transmissions may be repeated from each of the APs 105 until a response has been received from each of the STAs 115.

According to the second implementation, if one AP 105 receives a response from each of the STAs 115, that AP 105 may transmit a trigger frame to the STAs 115 indicating the STAs 115 to transmit their buffered uplink data. Alternatively, an AP 105 that covers each of the STAs 115 that have buffered uplink data may transmit the trigger frame to solicit the STAs 115 to transmit their buffered uplink data (for example, instead of beginning with the first AP 105 to transmit an NFRP). As described herein, one or more of the STAs 115 that may be reachable by the AP 105 transmitting the trigger frame may have indicated not having buffered uplink data to transmit. In this case, the AP 105 may transmit the trigger frame to only the STAs 115 that indicated having buffered uplink data to transmit.

In some implementations, one or more STAs 115 may not respond to the trigger frame as transmitted by the transmitting AP 105. In such implementations, according to the second implementation, the AP 105 that was previously able to reach that particular STA 115 may retry transmitting the trigger frame. For example, if the AP 105-d is at one point able to reach all of the STAs 115 (for example, in which each STA 115 has buffered uplink data to transmit), the AP 105-d may transmit a trigger frame to each of the STAs 115. However, the AP 105-d does not receive an uplink data transmission from, for example, the STA 115-c, for example, due to a change in the environment causing blockage in the communication link between the AP 105-d and the STA 115-c (for example, a robotic arm moving to block to the path). In this case, the AP 105-d may signal via a backhaul link to the last AP 105 (for example, the backhaul link 505-c to the AP 105-c) that was able to reach the STA 115-c to indicate to the AP 105 to transmit a further trigger frame for the uplink data of the STA 115-c.

A third possible implementation may include polling from multiple of the APs 105 to the associated STAs 115. In some examples, the polling may be from all of the virtual APs 105 (in other words, each of the APs 105 may separately transmit NFRPs). The multiple APs 105 may each transmit the NFRPs to solicit feedback from the STAs 115, as similarly described herein. In some examples, according to the third implementation, the multiple APs 105 may not wait until receiving signaling from another AP 105 to initiate NFRP polling.

According to the third implementation, an AP 105 that receives a response to its NFRP from a particular set of STAs 115 indicating that the STAs 115 have buffered uplink data to transmit, the AP 105 may transmit a corresponding trigger frame to each of the STAs 115 of the set of STAs 115. Additionally or alternatively, an AP 105 that is first to receive a response from each of the STAs 115 may first transmit the corresponding trigger frame to each of the STAs 115 of the set of STAs 115.

Additionally or alternatively, an AP 105 that covers each of the STAs 115 that have buffered uplink data may transmit the trigger frame to solicit the STAs 115 to transmit their buffered uplink data (for example, instead of beginning with the first AP 105 to transmit an NFRP). As described herein, one or more of the STAs 115 that may be reachable by the AP 105 transmitting the trigger frame may have indicated not having buffered uplink data to transmit. In this case, the AP 105 may transmit the trigger frame to only the STAs 115 that indicated having buffered uplink data to transmit. As similarly described herein, in some examples, one or more STAs 115 may not respond to the trigger frame as transmitted by the transmitting AP 105. In such examples, according to the second implementation, the AP 105 that was previously able to reach that particular STA 115 may retry transmitting the trigger frame.

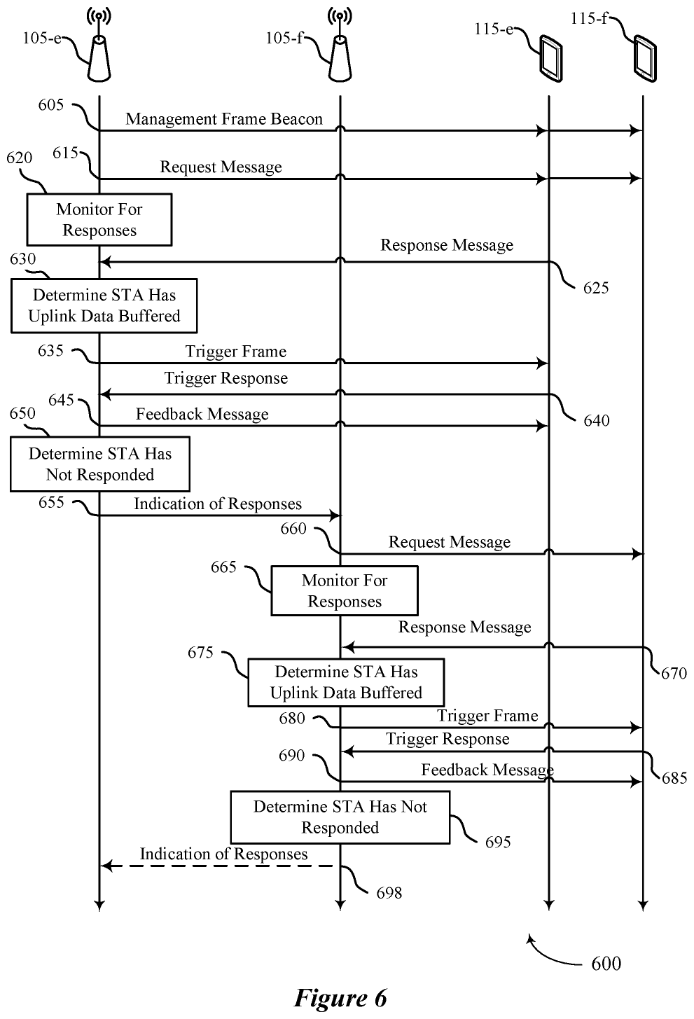

FIG. 6 illustrates an example of a process flow 600 that supports polling in wireless systems in accordance with aspects of the present disclosure. In some examples, the process flow 600 may implement aspects of the WLAN 100. The process flow 600 includes an AP cluster of APs 105 including a first AP 105-e, a second AP 105-f, and associated STAs 115 including a first STA 115-e and a second STA 115-f, each of which may be examples of the corresponding devices described with reference to FIGS. 1 through 5. While the process flow 600 shows an AP cluster including two APs 105 associated with two STAs 115, similar operations may be implemented at any number of APs 105 and any number of STAs 115.

At 605, the AP 105-e may transmit a management frame beacon, which may be received at the STA 115-e and the STA 115-f. The management frame beacon may indicate the master BSSID associated with a master AP 105, for example, in which the AP 105-e is the master AP 105. Alternatively, the management frame beacon may indicate the master BSSID associated with a master AP 105, for example, in which AP 105-e is not the master AP 105 and the second AP 105-f is the master AP 105.

At 615, the AP 105-e may transmit to a set of STAs 115 associated with the set of APs 105 of the AP cluster, including, for example, the STA 115-e and the STA 115-f, and the STA 115-e and the STA 115-f may receive from the AP 105-e, a request message. In some examples, the request message may indicate a master BSSID of the AP cluster. In some examples, and as illustrated in FIG. 6, the AP 105-e may be a master AP 105. In some examples, each AP 105 of the set of APs 105 of the AP cluster may correspond to a same multi-BSSID set. In some examples, the request message may include a NFRP and/or a basic trigger frame.

At 620, the AP 105-e may monitor for responses from the set of STAs 115 in response to the transmitted request message, as may have been transmitted at 615. In some implementations, the AP 105-e may associate a TA of the AP 105-e with the master BSSID corresponding to a master AP 105 of the AP cluster. For example, the AP 105-e may set the TA to the TxBSSID. In this way, a STA 115 that receives the request message may respond, as the STA 115 believes that the AP 105-e is from its respective BSS because the request message appears to originate from the TxBSSID with which the STA 115 believes it is associated.

At 625, the STA 115-e may transmit to the AP 105-e, and the AP 105-e may receive from the STA 115-e, a first response message. The AP 105-e may receive the first response message based on monitoring for responses at 620. In some implementations, response messages may be received from a subset of STAs 115 of the set of STAs 115 (as shown here, a response message is received from the STA 115-e, but not the STA 115-f). The response message may indicate to the AP 105-e whether or not the STA 115-e has buffered uplink data to transmit. For example, the STA 115-e may transmit a message including an IE including one or more bits that indicate that the STA 115 has buffered uplink data to transmit (for example, via a value of “1”) or that indicate that the STA 115 does not have buffered uplink data to transmit (for example, a value of “−1”).

At 630, the AP 105-e may determine that STA 115-e has uplink data buffered based on having received the first response message at 625. For example, based on the response message that the transmitting AP 105-e may receive at 625, the AP 105 may identify one or more STAs 115 that have buffered uplink data to transmit, (in other words, each STA 115 that indicated in its respective response message that the STA 115 has buffered uplink data to transmit) including, for example, the STA 115-e.

At 635, the AP 105-e may transmit respective trigger frames to each STA 115 of the set of STAs 115 based on the response messages received at 625, for example, that indicated the respective STA 115 has buffered uplink data to transmit. For example, as shown, the AP 105-e may transmit to the STA 115-e, and the STA 115-e may receive from the AP 105-e, a trigger frame in which the trigger frame may include the associated TA.

At 640, the STA 115-e may transmit to the AP 105-e, and the AP 105-e may receive from the STA 115-e, a trigger response. For example, the STA 115-e having received the trigger frame from the AP 105-e, and having buffered uplink data to transmit, may, transmit its respective buffered uplink data to the AP 105-e. In some examples, the trigger response may include a receiver address set to a MAC of a virtual AP associated with the STA 115-e. In some examples, the trigger response may be a trigger-based PPDU.

At 645, the AP 105-e may transmit to the STA 115-e, and the STA 115-e may receive from the AP 105-e, a feedback message in which a TA of the feedback message may be set to the receiver address.

At 650, the AP 105-e may determine, based on the monitoring at 620, that at least one STA 115 has not responded to the request message transmitted at 615. For example, as shown in FIG. 6, the AP 105-e did not receive a response from the STA 115-f.

At 655, the AP 105-e may transmit to at least one second AP 105 of the AP cluster, for example, the AP 105-f, and the AP 105-f may receive from the AP 105-e, an indication of whether responses were received from STAs 115 of the set of STAs 115. The indicating may be based on the monitoring for responses at 620. The indication to the AP 105-f may indicate that the at least one STA 115 (here, the STA 115-f) that has not responded to the request message transmitted at 615. The indication to the AP 105-f may further indicate that the first response message was received from the first STA 115-e at 625.

At 660, the AP 105-f may transmit to the STA 115-f, and the STA 115-f may receive from the AP 105-f, a second request message. In some examples, the AP 105-f may transmit the second request message based on the indication received from the AP 105-e at 655. In some examples, the second request message may indicate the master BSSID of the AP cluster. For example, the AP 105-f may associate a TA of the AP 105-e with the master BSSID corresponding to a master AP 105 in which the second request message includes the TA of the AP 105-e. For example, the AP 105-e may set the TA to the master BSSID. In this way, a STA 115 receiving the second request message believes that the AP 105-f is from its respective BSS and thus responds because the request message appears to originate from the BSS with which the STA 115 believes it is associated. In some examples, the second request message may include a NFRP and/or a basic trigger frame.

At 665, the AP 105-f may monitor for responses from the set of STAs 115 in response to the transmitting the second request message, as may have been transmitted at 660.

At 670, the STA 115-f may transmit to the AP 105-f, and the AP 105-f may receive from the STA 115-f, a response message in response to the second request message transmitted at 660 and based on the monitoring at 665. In some examples, response messages may be received from a subset of STAs 115 of the set of STAs 115 (as shown here, a response message is received from the STA 115-f).

At 675, the AP 105-f may determine that the STA 115-f has uplink data buffered based on the response message received at 670.

At 680, the AP 105-f may transmit respective trigger frames to each STA 115 of the set of STAs 115 based on the response messages received at 670, for example, that indicated the respective STA 115 has buffered uplink data to transmit. For example, as shown, the AP 105-f may transmit to the STA 115-f, and the STA 115-f may receive from the AP 105-f, a trigger frame in which the trigger frame may include the associated TA.

At 685, the STA 115-f may transmit to the AP 105-f, and the AP 105-f may receive from the STA 115-f, a trigger response. For example, the STA 115-f having received the trigger frame from the AP 105-f, and having buffered uplink data to transmit, may, transmit its respective buffered uplink data to the AP 105-f. In some examples, the trigger response may include a receiver address set to a MAC of a virtual AP with which the first STA is associated.

At 690, the AP 105-f may transmit to the STA 115-f, and the STA 115-e may receive from the AP 105-f, a feedback message. In some examples, a TA of the feedback message is set to the receiver address.

At 695, the AP 105-f may determine, based on the monitoring at 665, that at least one STA 115 has not responded to the request message transmitted at 660. For example, the AP 105-f may determine that it did not receive responses from one or more additional STAs 115 (not shown).

At 698, the AP 105-f may transmit to the AP 105-e, and the AP 105-e may receive from the AP 105-f, a backhaul message that indicates whether a response was received from the at least one STA 115 from which the AP 105-e did not originally receive a response (here, the STA 115-f). The AP 105-f may transmit the backhaul message based on the monitoring for responses at 665 and in response to the second request message transmitted at 660 and the response message received at 670.

Additionally or alternatively, the AP 105-f may transmit the backhaul message to a third AP 105 (not shown) that indicates whether the response was received by the AP 105-f, if, for example, there are still outstanding STAs 115 that have buffered uplink data to be transmitted. For example, the AP 105-f may determine that at least one STA 115 has not responded to the second request message, as transmitted at 660, based on the monitoring for responses at 665. In this case, the indication transmitted to the AP 105-e or the third AP 105 may indicate that the at least one STA 115 has not responded to the second request message as transmitted at 660. The third AP 105 may perform similar steps to attempt to receive the buffered uplink data from the STA 115. If the third AP 105 successfully receives the uplink data from the STA 115, the third AP 105 may transmit to the AP 105-f, and the AP 105-f may receive from the third AP 105, another backhaul message that indicates a response was received from the at least one STA 115 in which the response was received may be based on a third request message transmitted by the third AP.

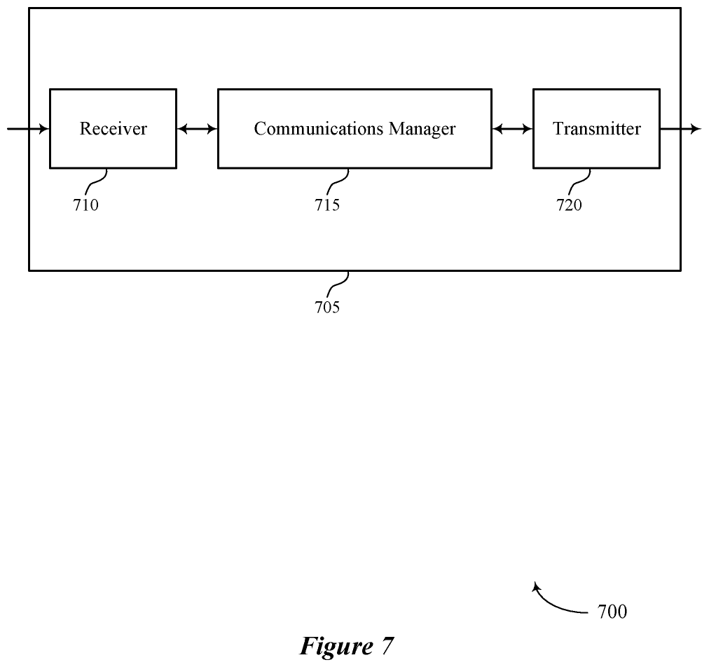

FIG. 7 shows a block diagram 700 of a device 705 that supports polling in wireless systems in accordance with aspects of the present disclosure. The device 705 may be an example of aspects of an AP as described herein. The device 705 may include a receiver 710, a communications manager 715, and a transmitter 720. The device 705 may also be implemented, at least in part, by one or both of a modem and a processor. Each of these components may be in communication with one another (for example, via one or more buses).

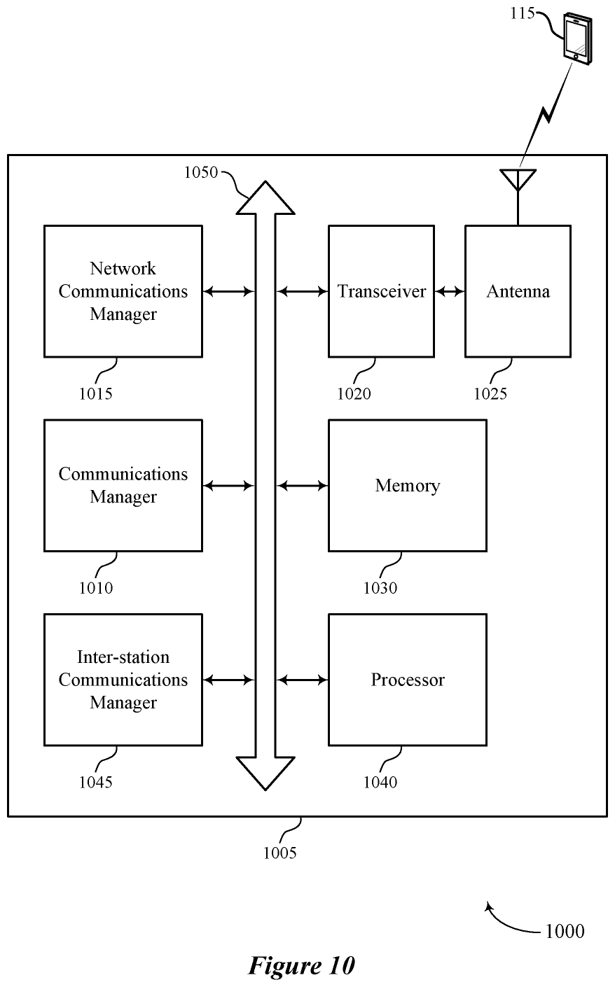

The receiver 710 may receive information such as packets, user data, or control information associated with various information channels (for example, control channels, data channels, and information related to polling in wireless systems, and the like). Information may be passed on to other components of the device. The receiver 710 may be an example of aspects of the transceiver 1020 described with reference to FIG. 10. The receiver 710 may utilize a single antenna or a set of antennas.

The communications manager 715 may transmit a request message to a set of STAs associated with the set of APs of the AP cluster, the request message indicating a master BSSID of the AP cluster, monitor for responses from the set of STAs in response to the transmitted request message, and transmit, to at least one second AP of the set of APs, an indication of whether responses were received from STAs of the set of STAs based on the monitoring. The communications manager 715 may also receive, from a second AP of the set of APs, an indication of whether responses to a first request message were received from STAs of a set of STAs associated with the set of APs in which the first request message indicates a master BSSID of the AP cluster, transmit a second request message based on the indication received from the at least one second AP in which the second request message indicates the master BSSID of the AP cluster, monitor for responses from the STAs of the set of STAs in response to the transmitted second request message, and transmit, to the at least one second AP or a third AP of the set of APs, an indication of whether responses were received from the STAs based on the monitoring. The communications manager 715 may be an example of aspects of the communications manager 1010 described herein.

The communications manager 715, or its sub-components, may be implemented in one or more of hardware, or code (for example, software or firmware) executed by a processor. The functions of the communications manager 715, or its sub-components may be executed by one or more of a general-purpose processor, a DSP, an ASIC, an FPGA or other programmable logic device, discrete gate or transistor logic, discrete hardware components, and so on.

The communications manager 715, or its sub-components, may be physically located at different locations, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to one or more of an input/output (I/O) component, a transceiver, a network server, another computing device, or one or more other components described in the present disclosure in accordance with various aspects of the present disclosure.

The transmitter 720 may transmit signals generated by other components of the device. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

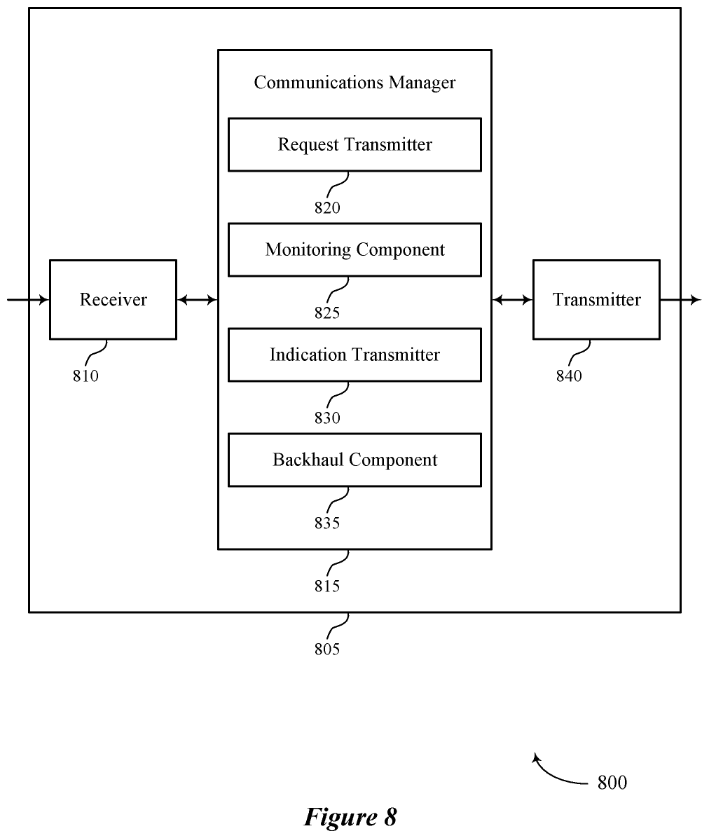

FIG. 8 shows a block diagram 800 of a device 805 that supports polling in wireless systems in accordance with aspects of the present disclosure. The device 805 may be an example of aspects of a device 705 or an AP 105 as described herein. The device 805 may include a receiver 810, a communications manager 815, and a transmitter 840. The device 805 may also be implemented, at least in part, by one or both of a modem and a processor. Each of these components may be in communication with one another (for example, via one or more buses).

The receiver 810 may receive information such as packets, user data, or control information associated with various information channels (for example, control channels, data channels, and information related to polling in wireless systems, and the like). Information may be passed on to other components of the device. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a request transmitter 820, a monitoring component 825, an indication transmitter 830, and a backhaul component 835. The communications manager 815 may be an example of aspects of the communications manager 1010 described herein.

The request transmitter 820 may transmit a request message to a set of STAs associated with the set of APs of the AP cluster, the request message indicating a master BSSID of the AP cluster.

The monitoring component 825 may monitor for responses from the set of STAs in response to the transmitted request message.

The indication transmitter 830 may transmit, to at least one second AP of the set of APs, an indication of whether responses were received from STAs of the set of STAs based on the monitoring.

The backhaul component 835 may receive, from at least one second AP of the set of APs, an indication of whether responses to a first request message were received from STAs of a set of STAs associated with the set of APs in which the first request message indicates a master BSSID of the AP cluster.

The request transmitter 820 may transmit a second request message based on the indication received from the at least one second AP in which the second request message indicates the master BSSID of the AP cluster.

The monitoring component 825 may monitor for responses from the STAs of the set of STAs in response to the transmitted second request message.

The indication transmitter 830 may transmit, to the at least one second AP or a third AP of the set of APs, an indication of whether responses were received from the STAs based on the monitoring.

The transmitter 840 may transmit signals generated by other components of the device. In some examples, the transmitter 840 may be collocated with a receiver 810 in a transceiver module. For example, the transmitter 840 may be an example of aspects of the transceiver 1020 described with reference to FIG. 10. The transmitter 840 may utilize a single antenna or a set of antennas.

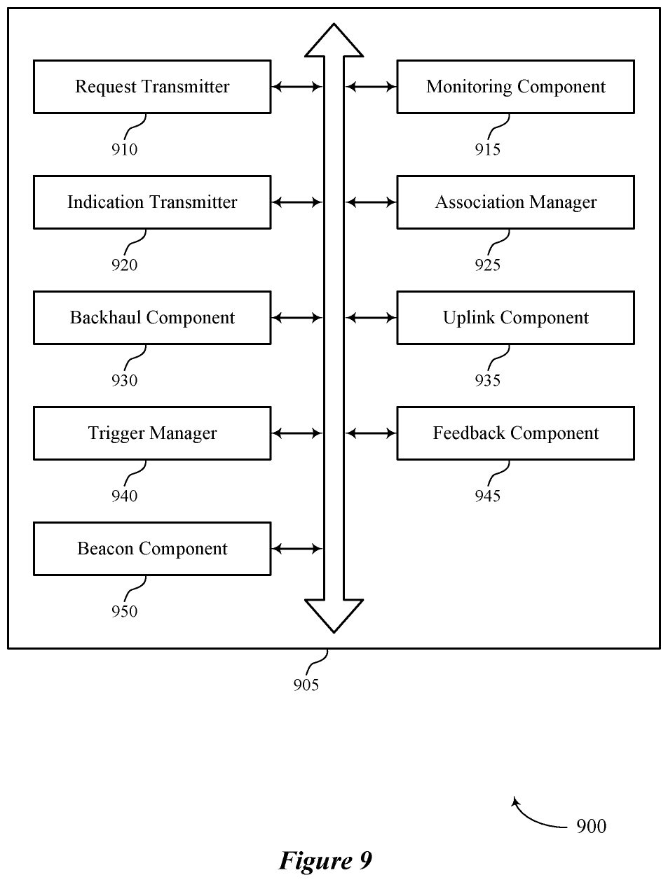

FIG. 9 shows a block diagram 900 of a communications manager 905 that supports polling in wireless systems in accordance with aspects of the present disclosure. The communications manager 905 may be an example of aspects of a communications manager 715, a communications manager 815, or a communications manager 1010 described herein. The communications manager 905 may include a request transmitter 910, a monitoring component 915, an indication transmitter 920, an association manager 925, a backhaul component 930, an uplink component 935, a trigger manager 940, a feedback component 945, and a beacon component 950. Each of these modules may communicate, directly or indirectly, with one another (for example, via one or more buses).

The request transmitter 910 may transmit a request message to a set of STAs associated with the set of APs of the AP cluster, the request message indicating a master BSSID of the AP cluster.

In some examples, the request transmitter 910 may transmit a second request message based on the indication received from the at least one second AP in which the second request message indicates the master BSSID of the AP cluster.

In some implementations, the first AP is a master AP.

In some examples, each AP of the set of APs corresponds to a same multi-BSSID set.

In some examples, the request message includes an NFRP or a basic trigger frame.

In some implementations, at least one of the first or the second request messages includes an NFRP or a basic trigger frame.

The monitoring component 915 may monitor for responses from the set of STAs in response to the transmitted request message.

In some examples, the monitoring component 915 may monitor for responses from the STAs of the set of STAs in response to the transmitted second request message.

In some examples, the monitoring component 915 may determine that at least one STA has not responded to the transmitted request message based on the monitoring in which the indication provided to the at least one second AP indicates that the at least one STA has not responded to the transmitted request message.

In some examples, the monitoring component 915 may receive a first response message from a first STA of the set of STAs in response to the transmitted request message based on the monitoring in which the indication provided to the at least one second AP indicates that the first response message was received from the first STA.

In some examples, the monitoring component 915 may receive response messages from a subset of STAs of the set of STAs based at least in part on the monitoring.

In some examples, the monitoring component 915 may receive response messages from each STA of the set of STAs.

In some examples, the monitoring component 915 may determine that at least one STA has not responded to the second request message based on the monitoring, in which the indication provided to the at least one second AP or the third AP indicates that the at least one STA has not responded to the second request message.

In some examples, the monitoring component 915 may receive a response message from a first STA of the set of STAs in response to the second request message based on the monitoring in which the indication provided to the first AP or a third AP indicates that the response message was received from the first STA.

In some examples, the monitoring component 915 may receive response messages from a subset of STAs of the set of STAs based at least in part on the monitoring.

In some examples, the monitoring component 915 may receive response messages from each STA of the set of STAs.

The indication transmitter 920 may transmit, to at least one second AP of the set of APs, an indication of whether responses were received from STAs of the set of STAs based on the monitoring.

In some examples, the indication transmitter 920 may transmit, to the at least one second AP or a third AP of the set of APs, an indication of whether responses were received from the STAs based on the monitoring.

The backhaul component 930 may receive, from at least one second AP of the set of APs, an indication of whether responses to a first request message were received from STAs of a set of STAs associated with the set of APs in which the first request message indicates a master BSSID of the AP cluster.

In some examples, the backhaul component 930 may receive, from the at least one second AP, a backhaul message that indicates a response from the at least one STA in which the response is received in response to a second request message transmitted by the at least one second AP.

In some examples, the backhaul component 930 may receive, from the third AP, a backhaul message that indicates a response was received from the at least one STA in which the response was received based on a third request message transmitted by the third AP.

In some implementations, the first AP is a master AP.

In some examples, each AP of the set of APs corresponds to a same multi-BSSID set.

The association manager 925 may associate a transmitter address of the first AP with the master BSSID corresponding to a master AP of the AP cluster in which the request message includes the transmitter address of the first AP.

In some examples, associating a transmitter address of the first AP with the master BSSID corresponding to a master AP in which the request message includes the transmitter address of the first AP.

The uplink component 935 may determine that the first STA of the set of STAs has uplink data buffered based on the first response message.

In some examples, the uplink component 935 may determine that the first STA of the set of STAs has uplink data buffered based on the first response message.

The trigger manager 940 may transmit a trigger frame to the first STA in which the trigger frame includes the transmitter address.

In some examples, receiving a trigger response from the first STA in which the trigger response includes a receiver address set to a MAC of a virtual AP associated with the first STA.

In some examples, the trigger manager 940 may transmit respective trigger frames to each of the subset of STAs having uplink data buffered based on the received response messages.

In some examples, the trigger manager 940 may transmit respective trigger frames to each STA of the set of STAs based on the received response messages.

In some examples, transmitting a trigger frame to the first STA in which the trigger frame includes the transmitter address.

In some examples, receiving a trigger response from the first STA in which the trigger response includes a receiver address set to a MAC of a virtual AP associated with the first STA.

In some examples, the trigger manager 940 may transmit respective trigger frames to each of the subset of STAs having uplink data buffered based on the received response messages.

In some examples, the trigger manager 940 may transmit respective trigger frames to each STA of the set of STAs based on the received response messages.

The feedback component 945 may transmit a feedback message to the first STA in which a transmitter address of the feedback message is set to the receiver address.

In some examples, the feedback component 945 may transmit a feedback message to the first STA in which a transmitter address of the feedback message is set to the receiver address.

The beacon component 950 may transmit a management frame beacon that indicates the master BSSID associated with a master AP, in which the first AP is the master AP.

In some examples, the beacon component 950 may transmit a management frame beacon that indicates the master BSSID associated with a master AP in which the first AP is a secondary AP.

FIG. 10 shows a diagram of a system 1000 including a device 1005 that supports polling in wireless systems in accordance with aspects of the present disclosure. The device 1005 may be an example of or include the components of device 705, device 805, or an AP as described herein. The device 1005 may include components for bi-directional voice and data communications including components for transmitting and receiving communications, including a communications manager 1010, a network communications manager 1015, a transceiver 1020, an antenna 1025, memory 1030, a processor 1040, and an inter-station communications manager 1045. These components may be in electronic communication via one or more buses (for example, bus 1050).

The communications manager 1010 may transmit a request message to a set of STAs associated with the set of APs of the AP cluster, the request message indicating a master BSSID of the AP cluster, monitor for responses from the set of STAs in response to the transmitted request message, and transmit, to at least one second AP of the set of APs, an indication of whether responses were received from STAs of the set of STAs based on the monitoring. The communications manager 1010 may also receive, from a second AP of the set of APs, an indication of whether responses to a first request message were received from STAs of a set of STAs associated with the set of APs in which the first request message indicates a master BSSID of the AP cluster, transmit a second request message based on the indication received from the second AP in which the second request message indicates the master BSSID of the AP cluster, monitor for responses from the STAs of the set of STAs in response to the transmitted second request message, and transmit, to the second AP or a third AP of the set of APs, an indication of whether responses were received from the STAs based on the monitoring.

The network communications manager 1015 may manage communications with the core network (for example, via one or more wired backhaul links). For example, the network communications manager 1015 may manage the transfer of data communications for client devices, such as one or more STAs 115.

The transceiver 1020 may communicate bi-directionally, via one or more antennas, wired, or wireless links as described herein. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some implementations, the wireless device may include a single antenna 1025. However, in some implementations the device may have more than one antenna 1025, which may be capable of concurrently transmitting or receiving multiple wireless transmissions.

The memory 1030 may include RAM and ROM. The memory 1030 may store computer-readable, computer-executable code 10 35 including instructions that, when executed, cause the processor to perform various functions described herein. In some examples, the memory 1030 may contain, among other things, a basic I/O system (BIOS) which may control basic hardware or software operation such as the interaction with peripheral components or devices.

The processor 1040 may include an intelligent hardware device, (for example, one or more of a general-purpose processor, a DSP, a CPU, a microcontroller, an ASIC, an FPGA, a programmable logic device, a discrete gate or transistor logic component, or a discrete hardware component). In some examples, the processor 1040 may be configured to operate a memory array using a memory controller. In other examples, a memory controller may be integrated into processor 1040. The processor 1040 may be configured to execute computer-readable instructions stored in a memory to perform various functions (for example, functions or tasks supporting polling in wireless systems).

The inter-station communications manager 1045 may manage communications with other AP 105, and may include a controller or scheduler for controlling communications with STAs 115 in cooperation with other APs 105. For example, the inter-station communications manager 1045 may coordinate scheduling for transmissions to STAs 115 for various interference mitigation techniques such as beamforming or joint transmission. In some examples, the inter-station communications manager 1045 may provide an X2 interface within an LTE/LTE-A wireless communications network technology to provide communication between APs 105.

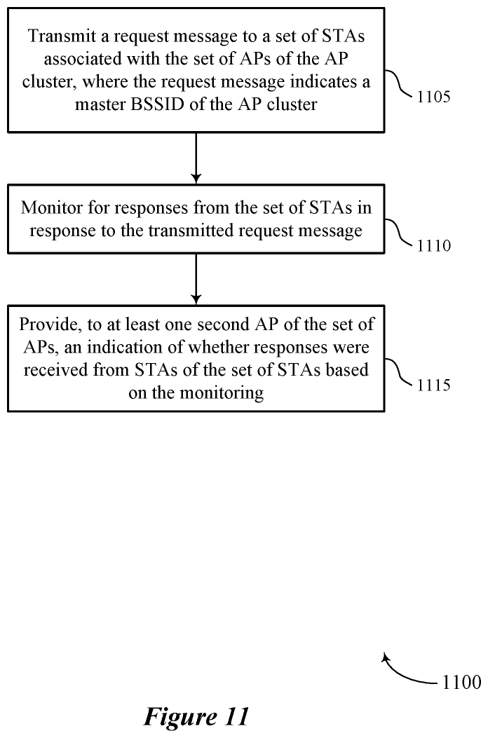

FIG. 11 shows a flowchart illustrating a method 1100 that supports polling in wireless systems in accordance with aspects of the present disclosure. The operations of method 1100 may be implemented by an AP or its components as described herein. For example, the operations of method 1100 may be performed by a communications manager as described with reference to FIGS. 7-10. In some examples, a AP may execute a set of instructions to control the functional elements of the AP to perform the functions described herein. Additionally or alternatively, an AP may perform aspects of the functions described herein using special-purpose hardware.

At 1105, the AP may transmit a request message to a set of STAs associated with the set of APs of the AP cluster, the request message indicating a master BSSID of the AP cluster. The operations of 1105 may be performed according to the methods described herein. In some examples, aspects of the operations of 1105 may be performed by a request transmitter as described with reference to FIGS. 7-10.

At 1110, the AP may monitor for responses from the set of STAs in response to the transmitted request message. The operations of 1110 may be performed according to the methods described herein. In some examples, aspects of the operations of 1110 may be performed by a monitoring component as described with reference to FIGS. 7-10.

At 1115, the AP may provide, to at least one second AP of the set of APs, an indication of whether responses were received from STAs of the set of STAs based on the monitoring. The operations of 1115 may be performed according to the methods described herein. In some examples, aspects of the operations of 1115 may be performed by an indication transmitter as described with reference to FIGS. 7-10.

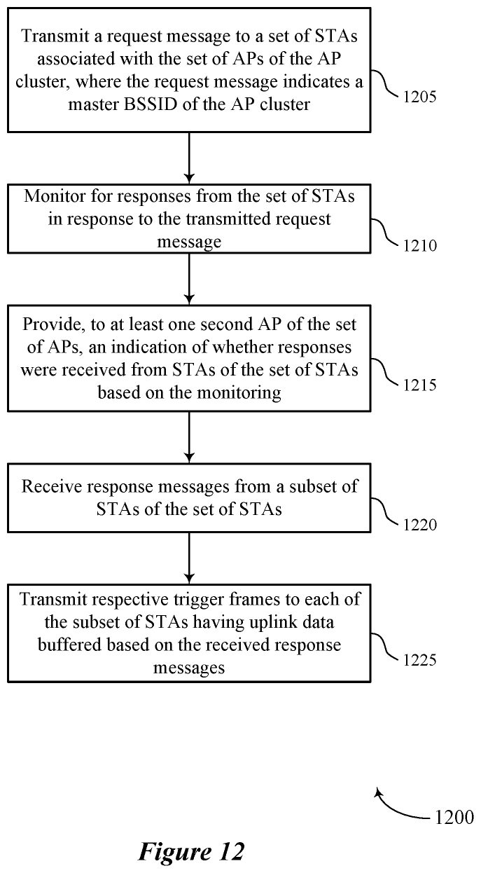

FIG. 12 shows a flowchart illustrating a method 1200 that supports polling in wireless systems in accordance with aspects of the present disclosure. The operations of method 1200 may be implemented by an AP or its components as described herein. For example, the operations of method 1200 may be performed by a communications manager as described with reference to FIGS. 7-10. In some examples, an AP may execute a set of instructions to control the functional elements of the AP to perform the functions described herein. Additionally or alternatively, an AP may perform aspects of the functions described herein using special-purpose hardware.

At 1205, the AP may transmit a request message to a set of STAs associated with the set of APs of the AP cluster, the request message indicating a master BSSID of the AP cluster. The operations of 1205 may be performed according to the methods described herein. In some examples, aspects of the operations of 1205 may be performed by a request transmitter as described with reference to FIGS. 7-10.

At 1210, the AP may monitor for responses from the set of STAs in response to the transmitted request message. The operations of 1210 may be performed according to the methods described herein. In some examples, aspects of the operations of 1210 may be performed by a monitoring component as described with reference to FIGS. 7-10.

At 1215, the AP may provide, to at least one second AP of the set of APs, an indication of whether responses were received from STAs of the set of STAs based on the monitoring. The operations of 1215 may be performed according to the methods described herein. In some examples, aspects of the operations of 1215 may be performed by an indication transmitter as described with reference to FIGS. 7-10.

At 1220, the AP may receive response messages from a subset of STAs of the set of STAs based at least in part on the monitoring. The operations of 1220 may be performed according to the methods described herein. In some examples, aspects of the operations of 1220 may be performed by a monitoring component as described with reference to FIGS. 7-10.

At 1225, the AP may transmit respective trigger frames to each of the subset of STAs having uplink data buffered based on the received response messages. The operations of 1225 may be performed according to the methods described herein. In some examples, aspects of the operations of 1225 may be performed by a trigger manager as described with reference to FIGS. 7-10.

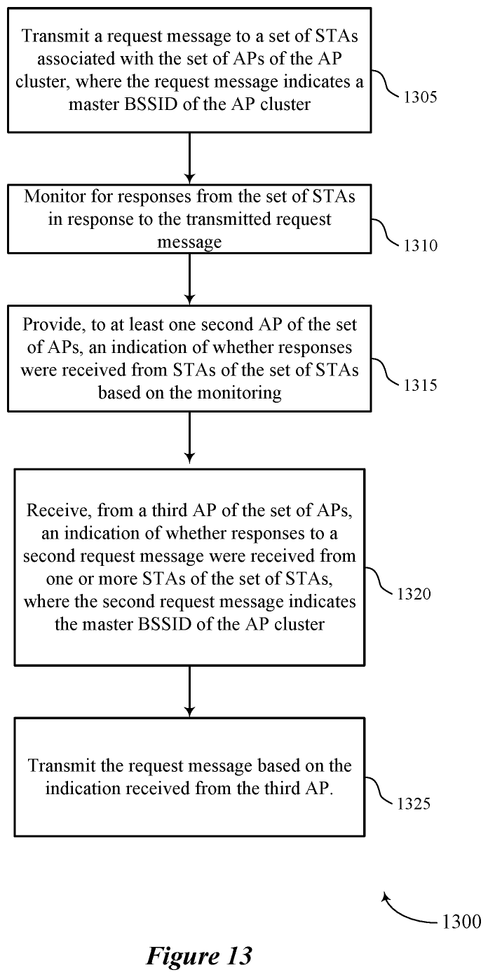

FIG. 13 shows a flowchart illustrating a method 1300 that supports polling in wireless systems in accordance with aspects of the present disclosure. The operations of method 1300 may be implemented by a AP or its components as described herein. For example, the operations of method 1300 may be performed by a communications manager as described with reference to FIGS. 7-10. In some examples, an AP may execute a set of instructions to control the functional elements of the AP to perform the functions described herein Additionally or alternatively, an AP may perform aspects of the functions described herein using special-purpose hardware.

At 1305, the AP may transmit a request message to a set of STAs associated with the set of APs of the AP cluster, the request message indicating a master BSSID of the AP cluster. The operations of 1305 may be performed according to the methods described herein. In some examples, aspects of the operations of 1305 may be performed by a request transmitter as described with reference to FIGS. 7-10.

At 1310, the AP may monitor for responses from the set of STAs in response to the transmitted request message. The operations of 1310 may be performed according to the methods described herein. In some examples, aspects of the operations of 1310 may be performed by a monitoring component as described with reference to FIGS. 7-10.

At 1315, the AP may provide, to at least one second AP of the set of APs, an indication of whether responses were received from STAs of the set of STAs based on the monitoring. The operations of 1315 may be performed according to the methods described herein. In some examples, aspects of the operations of 1315 may be performed by an indication transmitter as described with reference to FIGS. 7-10.

At 1320, the AP may receive, from a third AP of the set of APs, an indication of whether responses to a second request message were received from one or more STAs of the set of STAs in which the second request message indicates the master BSSID of the AP cluster. The operations of 1320 may be performed according to the methods described herein. In some examples, aspects of the operations of 1320 may be performed by a backhaul component as described with reference to FIGS. 7-10.

At 1325, the AP may transmit the request message based on the indication received from the third AP. The operations of 1325 may be performed according to the methods described herein. In some examples, aspects of the operations of 1325 may be performed by a request transmitter as described with reference to FIGS. 7-10.

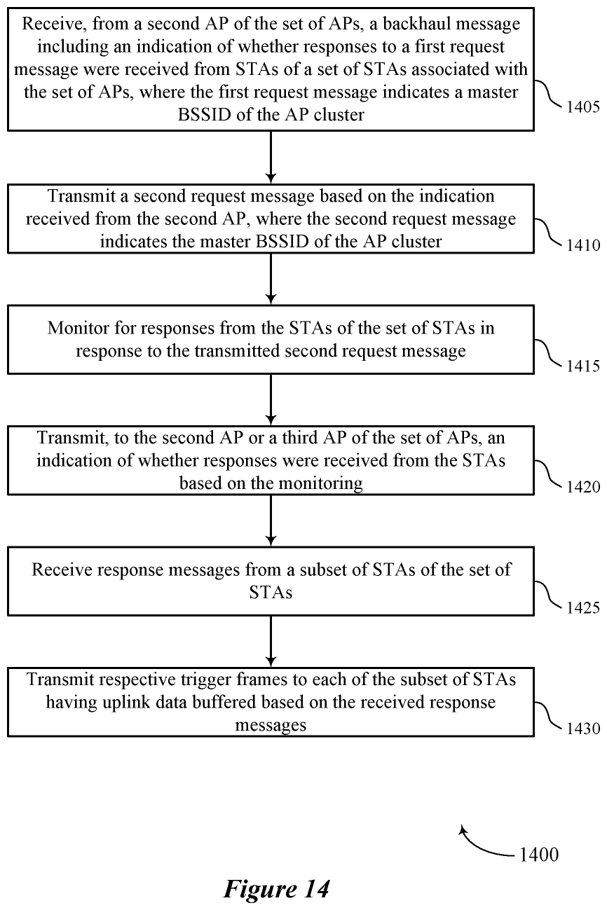

FIG. 14 shows a flowchart illustrating a method 1400 that supports polling in wireless systems in accordance with aspects of the present disclosure. The operations of method 1400 may be implemented by an AP or its components as described herein. For example, the operations of method 1400 may be performed by a communications manager as described with reference to FIGS. 7-10. In some examples, an AP may execute a set of instructions to control the functional elements of the AP to perform the functions described herein. Additionally or alternatively, a AP may perform aspects of the functions described herein using special-purpose hardware.

At 1405, the AP may receive, from at least one second AP of the set of APs, an indication of whether responses to a first request message were received from STAs of a set of STAs associated with the set of APs in which the first request message indicates a master BSSID of the AP cluster. The operations of 1405 may be performed according to the methods described herein. In some examples, aspects of the operations of 1405 may be performed by a backhaul component as described with reference to FIGS. 7-10.

At 1410, the AP may transmit a second request message based on the indication received from the at least one second AP in which the second request message indicates the master BSSID of the AP cluster. The operations of 1410 may be performed according to the methods described herein. In some examples, aspects of the operations of 1410 may be performed by a request transmitter as described with reference to FIGS. 7-10.

At 1415, the AP may monitor for responses from the STAs of the set of STAs in response to the transmitted second request message. The operations of 1415 may be performed according to the methods described herein. In some examples, aspects of the operations of 1415 may be performed by a monitoring component as described with reference to FIGS. 7-10.

At 1420, the AP may transmit, to the at least one second AP or a third AP of the set of APs, an indication of whether responses were received from the STAs based on the monitoring. The operations of 1420 may be performed according to the methods described herein. In some examples, aspects of the operations of 1420 may be performed by an indication transmitter as described with reference to FIGS. 7-10.

At 1425, the AP may receive response messages from a subset of STAs of the set of STAs based at least in part on the monitoring. The operations of 1425 may be performed according to the methods described herein. In some examples, aspects of the operations of 1425 may be performed by a monitoring component as described with reference to FIGS. 7-10.

At 1430, the AP may transmit respective trigger frames to each of the subset of STAs having uplink data buffered based on the received response messages. The operations of 1430 may be performed according to the methods described herein. In some examples, aspects of the operations of 1430 may be performed by a trigger manager as described with reference to FIGS. 7-10.

The methods described herein describe possible implementations, and that the operations and the steps may be rearranged or otherwise modified and that other implementations are possible. Furthermore, aspects from two or more of the methods may be combined.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), and so on. CDMA2000 covers IS-2000, IS-95, and IS-856 standards. IS-2000 Releases may be commonly referred to as CDMA2000 1×, 1×, and so on. IS-856 (TIA-856) is commonly referred to as CDMA2000 1×EV-DO, High Rate Packet Data (HRPD), and so on. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, and so on.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 of FIGS. 1 and 2—may include one or more carriers in which each carrier may be a signal made up of multiple sub-carriers (for example, waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by one or more voltages, currents, electromagnetic waves, magnetic fields or particles, or optical fields or particles.

The various illustrative blocks and modules described in connection with the disclosure herein may be implemented or performed with one or more of a general-purpose processor, a DSP, an ASIC, an FPGA or other programmable logic device, discrete gate or transistor logic, discrete hardware components, or any other device designed to perform the functions described herein. A general-purpose processor may be a microprocessor, but in the alternative, the processor may be any processor, controller, microcontroller, or state machine. A processor may also be implemented as a combination of computing devices (for example, a combination of a digital signal processing (DSP) and a microprocessor, multiple microprocessors, one or more microprocessors in conjunction with a DSP core, or any other such configuration).

The functions described herein may be implemented in one or more of hardware, software executed by a processor, or firmware. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at different locations, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of conditions. For example, aspects described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can include RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc in which disks usually reproduce data magnetically, while discs reproduce data optically with lasers. Combinations of the above are also included within the scope of computer-readable media.

The description herein is provided to enable a person having ordinary skill in the art to make or use the disclosure. Various modifications to the disclosure will be readily apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a first access point (AP) of a set of APs of an AP cluster, comprising:
transmitting a request message to a set of stations (STAs) associated with the set of APs of the AP cluster, the request message indicating a master basic service set identifier (BSSID) of the AP cluster;
monitoring for responses from the set of STAs in response to the transmitted request message; and
providing, to at least one second AP of the set of APs, an indication of whether responses were received from STAs of the set of STAs based at least in part on the monitoring.

2. The method of claim 1, wherein the request message comprises a transmitter address corresponding to a master AP of the AP cluster.

3. The method of claim 2, further comprising receiving a first response message from a first STA of the set of STAs in response to the transmitted request message based at least in part on the monitoring, wherein the indication provided to the at least one second AP indicates that the first response message was received from the first STA.

4. The method of claim 3, further comprising:
determining that the first STA of the set of STAs has uplink data buffered based at least in part on the first response message;
transmitting a trigger frame to the first STA, wherein the trigger frame comprises the transmitter address; and
receiving a trigger response from the first STA, wherein the trigger response comprises a receiver address set to a media access control (MAC) address of a virtual AP associated with the first STA.

5. The method of claim 4, further comprising transmitting a feedback message to the first STA, wherein a transmitter address of the feedback message is set to the receiver address.

6. The method of claim 2, wherein the first AP is the master AP of the set of APs.

7. The method of claim 6, further comprising transmitting a management frame beacon that indicates that the master BSSID is associated with the master AP.

8. The method of claim 1, further comprising determining that at least one STA has not responded to the transmitted request message based at least in part on the monitoring, wherein the indication provided to the at least one second AP indicates that the at least one STA has not responded to the transmitted request message.

9. The method of claim 8, further comprising receiving, from the at least one second AP, a backhaul message that indicates a response from the at least one STA.

10. The method of claim 1, wherein each AP of the set of APs corresponds to a same multiple basic service set ID (multi-BSSID) set.

11. The method of claim 1, further comprising:
receiving response messages from a subset of STAs of the set of STAs based at least in part on the monitoring; and
transmitting respective trigger frames to each of the subset of STAs having uplink data buffered based at least in part on the received response messages.

12. The method of claim 1, further comprising transmitting a management frame beacon that indicates the master BSSID is associated with a master AP, wherein the first AP is not the master AP.

13. The method of claim 1, wherein the request message comprises a trigger frame.

14. The method of claim 13, wherein the trigger frame comprises a Null Data Packet (NDP) Feedback Report Poll (NFRP).

15. The method of claim 1, further comprising:
receiving, from a third AP of the set of APs, an indication of whether responses to a second request message were received from one or more STAs of the set of STAs, wherein the second request message indicates the master BSSID of the AP cluster, and wherein the transmitting of the request message is based at least in part on the indication received from the third AP.

16. An apparatus for wireless communications at a first access point (AP) of a set of APs of an AP cluster, comprising:
a processor,
memory in electronic communication with the processor; and
instructions stored in the memory and executable by the processor to cause the apparatus to:
transmit a request message to a set of stations (STAs) associated with the set of APs of the AP cluster, the request message indicating a master basic service set identifier (BSSID) of the AP cluster;
monitor for responses from the set of STAs in response to the transmitted request message; and
provide, to at least one second AP of the set of APs, an indication of whether responses were received from STAs of the set of STAs based at least in part on the monitoring.

17. The apparatus of claim 16, wherein the request message comprises a transmitter address corresponding to a master AP of the AP cluster.

18. The apparatus of claim 17, wherein the instructions are further executable by the processor to cause the apparatus to receive a first response message from a first STA of the set of STAs in response to the transmitted request message based at least in part on the monitoring, wherein the indication provided to the at least one second AP indicates that the first response message was received from the first STA.

19. The apparatus of claim 18, wherein the instructions are further executable by the processor to cause the apparatus to:
determine that the first STA of the set of STAs has uplink data buffered based at least in part on the first response message;
transmit a trigger frame to the first STA, wherein the trigger frame comprises the transmitter address; and
receive a trigger response from the first STA, wherein the trigger response comprises a receiver address set to a media access control (MAC) address of a virtual AP associated with the first STA.

20. The apparatus of claim 19, wherein the instructions are further executable by the processor to cause the apparatus to:
transmit a feedback message to the first STA, wherein a transmitter address of the feedback message is set to the receiver address.

21. The apparatus of claim 17, wherein the first AP is the master AP of the set of APs.

22. The apparatus of claim 21, wherein the instructions are further executable by the processor to cause the apparatus to transmit a management frame beacon that indicates that the master BSSID is associated with the master AP.

23. The apparatus of claim 16, wherein the instructions are further executable by the processor to cause the apparatus to determine that at least one STA has not responded to the transmitted request message based at least in part on the monitoring, wherein the indication provided to the at least one second AP indicates that the at least one STA has not responded to the transmitted request message.

24. The apparatus of claim 23, wherein the instructions are further executable by the processor to cause the apparatus to receive, from the at least one second AP, a backhaul message that indicates a response from the at least one STA.

25. The apparatus of claim 16, wherein each AP of the set of APs corresponds to a same multiple basic service set ID (multi-BSSID) set.

26. The apparatus of claim 16, wherein the instructions are further executable by the processor to cause the apparatus to:
receive response messages from a subset of STAs of the set of STAs based at least in part on the monitoring; and
transmit respective trigger frames to each of the subset of STAs having uplink data buffered based at least in part on the received response messages.

27. The method of claim 16, further comprising transmitting a management frame beacon that indicates the master BSSID is associated with a master AP, wherein the first AP is not the master AP.

28. The apparatus of claim 16, wherein the request message comprises a trigger frame.

29. The apparatus of claim 28, wherein the trigger frame comprises a Null Data Packet (NDP) Feedback Report Poll (NFRP).

30. The apparatus of claim 16, wherein the instructions are further executable by the processor to cause the apparatus to:
receive, from a third AP of the set of APs, an indication of whether responses to a second request message were received from one or more STAs of the set of STAs, wherein the second request message indicates the master BSSID of the AP cluster, and wherein the transmitting of the request message is based at least in part on the indication received from the third AP.
